(19) United States
(12) Patent Application Publication
(10) Pub. No.: US 2024/0352285 A1
(43) Pub. Date: Oct. 24, 2024

(54) SELF-ADHESIVE TAPE WITH MOPP CARRIER

(71) Applicant: tesa SE, Norderstedt (DE)

(72) Inventors: Thilo DOLLASE, Hamburg (DE); Jan AUGENSTEIN, Hamburg (DE); Johan HAITEL, Hamburg (DE); Elia Raquel ULLOA VILLANUEVA, Hamburg (DE); Patrick KEREP, Ellerbek (DE)

(73) Assignee: tesa SE, Norderstedt (DE)

(21) Appl. No.: 18/640,414

(22) Filed: Apr. 19, 2024

(30) Foreign Application Priority Data
Apr. 19, 2023 (DE) 10 2023 109 899.3

(51) Int. Cl. C09J 7/38; C09J 7/24

(52) U.S. Cl. CPC C09J 7/387; C09J 7/243; C09J 2301/312; C09J 2301/414; C09J 2423/16

(57) ABSTRACT

The present invention relates to a self-adhesive tape comprising a carrier composed of a monoaxially oriented polypropylene film and a pressure-sensitive adhesive adapted to the carrier, to a method for producing the self-adhesive tape and to its use.

The present invention relates to a self-adhesive tape comprising a carrier composed of a monoaxially oriented polypropylene film (MOPP) and a pressure-sensitive adhesive adapted to the carrier, to a method for producing the self-adhesive tape and to its use.

Self-adhesive tapes are used in order, among other things, to secure movable parts during transport, for example in refrigerators, and to bundle objects such as pipes, profiles or stacked cartons, for example. A common feature of these applications is that movable parts are securely fixed by the adhesive tape during transport, but the adhesive tape must be able to be removed again after transport without any residue. In addition to sufficient peel adhesion, the residue-free detachability from various substrates remains a particular challenge. Common substrates from which the adhesive tape must be able to be detached without residue and damage even after prolonged storage at different temperatures are plastics such as PS, PP and PE, various metals, and also solventborne and water-based, solvent-free or powder-applied coatings. A common product structure of such self-adhesive tapes generally contains a carrier and a pressure-sensitive adhesive, where monoaxially oriented polypropylene film (MOPP) is often used as a carrier for economic reasons. However, this film has the disadvantage of low internal strength, which can lead to splitting of the film in the z-direction when the adhesive tape is detached, which in turn leaves unwanted residues on the bonding base. In the state of the art, a number of attempts have been made to counter these disadvantages and to optimize the carrier material.

WO 2014/029664 discloses an adhesive tape having a carrier composed of a film on which at least on one side an adhesive is applied, the film being a monoaxially oriented film of polypropylene containing at least 80% by weight of polypropylene which has been previously processed at least once, preferably extruded at least once, where the film has a draw ratio on orientation in the longitudinal direction of 1:4 to 1:10.

DE 10 2017 203 066 describes an adhesive tape having a carrier composed of a film on which at least on one side an adhesive is applied, the film being a monoaxially oriented film, which consists of at least 95% by weight of polypropylene compositions having different phases, comprising: (i) 80 to 99% by weight of a polypropylene matrix comprising a propylene homopolymer, and (ii) 1 to 20% by weight of an elastomer in the form of an ethylene-propylene copolymer having an ethylene content of 50 to 90% by weight.

DE 10 2020 214 722 provides an adhesive tape having a carrier composed of a film on which at least on one side an adhesive is applied, the film being a film monoaxially oriented in the longitudinal direction, containing at least 90% by weight of polyester polymers.

MOPP films are valued for their high tensile strength in machine direction. From an economic point of view, it is not always advantageous to implement specific carrier systems, especially for smaller batch sizes. Therefore, there is still a need for improved self-adhesive tapes with MOPP film carriers.

Against this background, the present invention sees its object as providing a self-adhesive tape with MOPP carrier which overcomes the disadvantages of the prior art and is distinguished above all by improved redetachability. This object is achieved by a self-adhesive tape according to the main claim. Preferred developments of the self-adhesive tape of the invention are set out in the subclaims.

It has surprisingly been found that the common MOPP film carriers can be used advantageously if they are combined with an appropriately adapted pressure-sensitive adhesive. In this way, self-adhesive tapes can be realized which show an improved redetachability compared to conventional self-adhesive tapes.

A first subject of the present invention is therefore a self-adhesive tape comprising a carrier composed of a monoaxially oriented polypropylene film and a pressure-sensitive adhesive which comprises:
a) 38 to 65% by weight of an elastomer component;
b) 8 to 45% by weight of a tackifier resin component; and
c) 3 to 22% by weight of a reinforcing component,
   where the weight data refer in each case to the total weight of the pressure-sensitive adhesive and the sum of the fractions of elastomer component and reinforcing component in the pressure-sensitive adhesive is at least 52% by weight, based on the total weight of the pressure-sensitive adhesive.

### i) Carrier

As the carrier of the self-adhesive tape of the invention, common MOPP films can be used, as they are available commercially. MOPP is produced from polypropylene by extrusion and subsequent stretching. The film may be composed of pure polypropylene, i.e. only of propylene monomers. Polypropylene random copolymers or polypropylene block copolymers are also suitable. Suitable comonomers include olefins, particularly ethylene and/or butylene, where the fraction of comonomers in the polypropylene is preferably less than 50% by weight, particularly preferably less than 30% by weight, more particularly less than 20% by weight, based in each case on the total weight of the film. According to the invention, films composed of a blend of polypropylene and at least one other polymer can also be used, where the fraction of the other polymer or polymers is preferably less than 15% by weight, particularly preferably less than 10% by weight, more particularly less than 5% by weight, based in each case on the total weight of the film. Polyethylene in particular can be used as a further polymer.

In the context of the present invention, a MOPP film comprising or consisting of recycled polypropylene can also be used as a carrier. The recycled polypropylene is preferably that which has been previously processed at least once, preferably extruded at least once. Suitable material is, for example, edge trimmings as are obtained during the production of polypropylene films. Further suitable carrier films are described, for example, in WO 2018/154106 and WO 2014/029664.

The thickness of the carrier film can be adjusted as required, but after orientation it preferably lies in the range from 20 to 150 μm, particularly preferably from 25 to 100 μm, more particularly 50 to 100 μm.

For the production of the carrier film, it may be appropriate to add additives and other components that improve the film-forming properties, influence the tendency to form crystalline segments and/or selectively improve or, where appropriate, impair the mechanical properties.

The carrier film may contain pigments or other colorants and therefore may be coloured, white, grey or black. It may also contain additives such as, in particular, stabilizers and/or fillers.

### ii) Pressure-Sensitive Adhesive

It has surprisingly been found that the use of the pressure-sensitive adhesive provided according to the invention made it possible to improve, in particular, the redetachability of the self-adhesive tape of the invention.

### a) Elastomer Component

In the prior art, synthetic and natural rubbers in particular are used as pressure-sensitive adhesives in conjunction with MOPP films. In the context of the present invention, it has been proven advantageous to use polydiene block copolymers. In one preferred embodiment, the pressure-sensitive adhesive therefore comprises at least one polydiene block copolymer, more particularly a polyvinylaromatic-polydiene block copolymer. However, polydiene block copolymers can also be used in which the polydiene blocks are hydrogenated.

Preferably, the fraction of the polydiene block copolymers in the elastomer component is at least 90% by weight, based on the total weight of the elastomer component. Polydienes are preferred which derive from a conjugated diene, in particular from a 1,3-diene.

In one preferred embodiment, the elastomer component is in the form of polyvinylaromatic-polydiene block copolymers having a structure of the form A-B-A, (A-B)ₙ, (A-B)ₙX or (A-B-A)ₙX wherein
the blocks A independently of each other are a polymer formed by polymerization of at least one vinylaromatic;
the blocks B independently of each other are a polymer formed by polymerization of one or more conjugated dienes having 4 to 18 C atoms;
X is the radical of a coupling reagent or polyfunctional initiator, and
n is an integer ≥2.

The polyvinylaromatic-polydiene block copolymers preferably each comprise one or more rubber-like blocks B (elastomer blocks, soft blocks) and at least two glass-like blocks A (hard blocks). Particularly preferred in the embodiment described here is at least one polyvinylaromatic-polydiene block copolymer having a structure A-B-A, (A-B)₂X, (A-B)₃X or (A-B) 4X, where for A, B and X the above meanings apply. Preferably, the elastomer component contains at least one triblock copolymer or higher multiblock copolymer, which may be linear or multi-arm, such as radial or star-shaped.

Based on the totality of all polyvinylaromatic-polydiene block copolymers of the elastomer component, polyvinylaromatic-polydiene block copolymers having a peak molar mass of at least 90 000 g/mol, more preferably of at least 120 000 g/mol, are preferred. Preferably, the peak molar mass of the polyvinylaromatic-polydiene block copolymers used is not more than 250 000 g/mol. Such polyvinyl aromatic polydiene block copolymers are present preferably at at least 30% by weight, preferably at least 40% by weight, more preferably at least 50% by weight, and very preferably at least 60% by weight, and preferably at most 90% by weight, based on the total weight of the elastomer component. The peak molar mass can be determined by GPC (Test Ia) according to the method described in the “Test Methods” section.

The elastomer component may also contain one or more diblock copolymers A-B. However, too high a fraction of diblock copolymers generally has a negative effect on the thermal shear strength. Their fraction in the pressure-sensitive adhesive should therefore not be too high. Particularly preferably, the average diblock fraction of the polyvinylaromatic-polydiene block copolymers, based on the totality of all polyvinylaromatic-polydiene block copolymers of the elastomer component, is a maximum of 40% by weight, in particular a maximum of 30% by weight and very particularly preferably a maximum of 25% by weight. In particular, the pressure-sensitive adhesive of the self-adhesive tape of the invention comprises a mixture of polyvinylaromatic-polydiene block copolymers having a structure A-B, A-B-A, (A-B)₃X or (A-B)₄X, which particularly preferably comprises a radial block copolymer and/or triblock copolymers A-B-A. Also preferred is a mixture of triblock copolymers and (A-B)ₙ or (A-B)ₙX block copolymers with n equal to or greater than 3. The block copolymers resulting from the A and B blocks may in principle contain identical or different B blocks. The block copolymers may have linear A-B-A structures, be of radial shape, and comprise star-shaped and linear multiblock copolymers.

Vinylaromatics for the structure of block A preferably comprise styrene and styrene derivatives, especially preferably styrene and α-methylstyrene. Block A can be a homo- or copolymer. Block A is particularly preferably a polystyrene block. Instead of the preferred polystyrene blocks, vinylaromatics used may also be polymer blocks based on other aromatic-containing homo- and copolymers, preferably on C8 to C12 aromatics, in particular with glass transition temperatures of greater than 75° C., for example, a-methylstyrene-containing aromatic blocks. For example, the glass transition temperature can be determined by means of DSC (Test II).

The polyvinylaromatic-polydiene block copolymers used according to the invention may contain identical or different A blocks. Preferably, the polyvinylaromatic-polydiene block copolymers have polystyrene end blocks. The monomers for the soft block B are preferably conjugated dienes, in particular those selected from the group consisting of butadiene, isoprene, ethylbutadiene, phenylbutadiene, piperylene, pentadiene, hexadiene, ethylhexadiene, farnesene and dimethylbutadiene and any mixtures of these monomers. The B block may also be in the form of a homopolymer or copolymer. Particularly preferably, the monomers for the soft block B are selected from butadiene and isoprene. For example, the soft block B is a polyisoprene block or a polybutadiene block or a polymer block of a mixture of butadiene and isoprene. Block B is very particularly preferably a polyisoprene. The soft blocks B produced from these preferred and other diene monomers may also be hydrogenated and be correspondingly present in particular as poly(ethylene-co-butylene) or poly(ethylene-co-propylene) blocks.

The A blocks of the polyvinylaromatic-polydiene block copolymers preferably have a glass transition temperature of at least 25° C., in particular at least 50° C. A glass transition temperature of a maximum of 0° C., in particular a maximum of −25° C., is preferred for the B blocks. These data refer to the pure, unblended block copolymers and are determined according to the invention by means of DSC (Test II).

The fraction of A block in the polyvinylaromatic-polydiene block copolymers is preferably at least 12% by weight and at maximum 40% by weight, more preferably at least 15% by weight and preferably at maximum 20% by weight. Preferably, the fraction of the totality of all polyvinylaromatic-polydiene block copolymers, based on the total elastomer component, is at least 38% by weight and a maximum of 65% by weight, more preferably at least 42% by weight and a maximum of 60% by weight. It has been found that too low a fraction of polyvinylaromatic-polydiene block copolymers causes the thermal shear strength of the pressure-sensitive adhesive to decrease, whereas too high a fraction of polyvinylaromatic-35 polydiene block copolymers causes the pressure-sensitive adhesive to lose too much adhesiveness, making the self-adhesive tape no longer suitable for certain applications.

The block copolymers resulting from the A and B blocks may comprise identical or different B blocks, including in terms of the microstructure. “Microstructure” refers to the relative ratio of the monomer linkage types possible for polybutadiene, polyisoprene or another conjugated diene, in particular 1,3-diene, namely 1,4-cis (in polybutadiene and polyisoprene), 1,4-trans (in polybutadiene and polyisoprene), 1,2 (in polybutadiene and polyisoprene) and 3,4 (in polyisoprene). It can be determined by comparing the integrals of the signals to be assigned to the corresponding groups via 1H-NMR. Preferably, the 1,4 fraction (cis+trans) is >80% by weight, more preferably >85% by weight, each based on the polydiene blocks, and the 1,4-cis fraction is >40% by weight, based on the polydiene blocks; accordingly, the fraction of 1,2- and/or any 3,4-linked monomers present in total, i.e. the so-called vinyl fraction, is preferably less than 20% by weight, more preferably a maximum of 17% by weight, in particular at most 13% by weight. A high fraction of 1,4 linkage and in particular 1,4-cis linkage of the monomer units in the polydiene blocks or a low fraction of vinyl groups leads to a lower glass transition temperature, so that good shock resistance can be achieved even in cold environments. For this reason too, polybutadiene is a preferred monomer for the B block or the B blocks. In one alternative embodiment, the quantitative figures for the types of monomer linkage, such as for the vinyl fraction in particular, relate not to % by weight but instead to mol %.

The above figures for the molar mass of the block copolymers refer to the polymer mode which can be assigned by the skilled person to the block copolymer architecture mentioned in the corresponding context. In this context, figures for the molar mass are to be understood as peak molar mass. GPC usually allows the determination of the molar mass of the individual polymer modes in a mixture of different block copolymers.

In one particularly preferred embodiment, the elastomer component is a styrene-butadiene-styrene block copolymer (SBS) or a styrene-isoprene-styrene block copolymer (SIS), in particular an SIS block copolymer. Furthermore, hydrogenated block copolymers such as styrene-(ethylene-co-butylene)-styrene block copolymer (SEBS) and styrene-(ethylene-co-propylene)-styrene block copolymer (SEPS) can be used.

### b) Tackifier Resin Component

According to the invention, the pressure-sensitive adhesive further comprises a tackifier resin component in addition to the elastomer component. The tackifier resin component is used in particular to set the adhesion in a desired manner. According to the general understanding of the skilled person, a “tackifier resin” is understood to mean an oligomeric or polymeric resin that increases the adhesion, i.e. the intrinsic stickiness, of the pressure-sensitive adhesive in comparison to an otherwise identical pressure-sensitive adhesive nevertheless not containing any tackifier resin. Tackifier resins are specific compounds with low molar mass compared to elastomers, usually with a weight-average molecular weight Mw of less than 5000 g/mol. Typically, the weight-average molecular weight of a tackifier resin component used in the context of the present invention is from 400 to 5000 g/mol, preferably from 500 to 2000 g/mol, determined by GPC (Test Ib).

The tackifier resin component is not to be understood as a reinforcing component within the context of the present invention, i.e. the tackifier resin component is preferably substantially not compatible with the hard blocks of the polydiene block copolymers.

The tackifier resin component is in particular compatible with the elastomer component and here especially with the polydiene blocks. Hydrocarbon resins or polyterpene resins have proven suitable particularly in cases where polyvinylaromatic-polydiene block copolymers are used. Therefore, tackifier resins are preferably used in which at least 75% by weight, based on the total weight of the tackifier resin component, are hydrocarbon resins or polyterpene resins or a mixture of the same.

Preferably, the tackifier resin component of the pressure-sensitive adhesive contains at least 75% by weight, based on the tackifier resin component, of at least one tackifier resin which has a DACP (diacetone alcohol cloud point, Test IIIa) of at least −20° C., preferably at least 0° C., very preferably at least +20° C. Furthermore, the tackifier resin component preferably has a softening temperature (ring & ball, Test IV) of at least +85° C., preferably at least +100° C. and at most +140° C. Methods for determining the DACP and the softening temperature are given in the “Test Methods” section.

Preferably, the tackifier resin component is selected from the group consisting of non-polar hydrocarbon resins, preferably hydrogenated and non-hydrogenated polymers of dicyclopentadiene (DCPD); non-hydrogenated, partially, selectively or fully hydrogenated hydrocarbon resins based on C5 or C5/C9 monomer streams, or partially, selectively or fully hydrogenated hydrocarbon resins based on C9 monomer streams. Other tackifier resins that can be used for the tackifier resin component are polyterpene resins based on α-pinene and/or β-pinene and/or β-limonene, which may also be hydrogenated.

The above-mentioned tackifier resins can be used both alone and in a mixture. Hydrogenated hydrocarbon resins such as hydrogenated C5 resins, hydrogenated C9 resins and/or hydrogenated DCPD resins are preferentially suitable in combination with polyisoprene block copolymer(s).

However, oxygen-containing tackifier resins such as terpene-phenol resins or rosin-containing resins, in particular rosin esters, are also conceivable. Rosin resins and rosin ester resins may be hydrogenated or non-hydrogenated or disproportionated or otherwise stabilized.

The fraction of tackifier resin component in the pressure-sensitive adhesive has a positive effect on the bond strength. The tackifier resin fraction ought therefore not to be too low. However, it has been shown that too high a fraction of tackifier resin(s) has a negative effect on the thermal shear strength and, in particular, on the redetachability. The fraction of tackifier resin component for the purposes of this invention is therefore at least 8% by weight and a maximum of 45% by weight, preferably a maximum of 40% by weight, very preferably a maximum of 35% by weight, based in each case on the total weight of the pressure-sensitive adhesive. A resin fraction of a maximum of 30% by weight or even a maximum of 20% by weight is also very advantageous.

### c) Reinforcing Component

Without being bound to any particular theory, it is assumed that in particular the presence of the reinforcing component in conjunction with the MOPP film as a carrier provides for the improved redetachment properties of the self-adhesive tape of the invention.

The reinforcing component is not to be understood as a tackifier resin component within the scope of the present invention, i.e. the reinforcing component is preferably substantially incompatible with the soft blocks, i.e. the polydiene blocks.

In particular, so-called end block reinforcers are used as the reinforcing component according to the invention.

End block reinforcers are those materials that are substantially compatible with the hard blocks of the polydiene block copolymers.

According to the invention, the reinforcing component is at least one resin.

If the hard block types are polyvinylaromatic blocks, the reinforcing component is preferably at least one resin based on at least one, in particular aromatic, hydrocarbon compound, preferably obtained from C8 and/or C9 streams and preferably selected from the group consisting of styrene, alpha-methylstyrene, para-methylstyrene, indene, methylindene and copolymers thereof. An oxygen-containing resin such as terpene-phenol resins, indene-coumarone resins or phenol-modified aromatic resins can also be selected for the reinforcing component.

The at least one resin of the reinforcing component has a weight-average molecular weight Mw of at least 800 g/mol, preferably from 1000 g/mol to 15 000 g/mol, more preferably 2000 g/mol to 10 000 g/mol, determined by means of GPC (Test Ib).

The at least one resin of the reinforcing component has a mixed methylcyclohexane aniline cloud point (MMAP; Test IIIb) of not more than 30° C., preferably of not more than 20° C.

The softening point of the at least one resin of the reinforcing component is preferably at least 130° C., more preferably at least 140° C., particularly preferably at least 150° C., determined according to Test IV.

The fraction of the reinforcing component, based on the total weight of the pressure-sensitive adhesive, is at least 3% by weight and at most 22% by weight, preferably at least 8% by weight and at most 18% by weight.

It has emerged that the fraction of the elastomer component and the fraction of the reinforcing component have a beneficial influence on the performance of MOPP-containing self-adhesive tapes. In this case, it has proved to be particularly advantageous in terms of redetachability if the pressure-sensitive adhesive is composed largely of elastomer component and reinforcing component. Therefore, the sum of the fractions of elastomer component and reinforcing component in the pressure-sensitive adhesive is at least 52% by weight, based on the total weight of the pressure-sensitive adhesive. Furthermore, an embodiment is preferred in which the sum of elastomer component and reinforcing component is at least 55% by weight, in particular at least 60% by weight, based on the total weight of the pressure-sensitive adhesive.

In the context of the present invention, the expression “substantially incompatible” or “substantially not compatible” is understood in particular to mean that the constituents or components referred to are at most 10% by weight, preferably at most 5% by weight, miscible with each other.

In the context of the present invention, the expression “substantially compatible” is understood in particular to mean that the constituents or components referred to are at least 90% by weight, preferably at least 95% by weight, miscible with each other.

### d) Further Components

The pressure-sensitive adhesive of the self-adhesive tape of the invention may contain further components in addition to the components mentioned. Particularly preferably, the pressure-sensitive adhesive further comprises a plasticizer component.

The plasticizer component is primarily used for the final fine adjustment of the cohesion/adhesion balance. Preferably, the plasticizer component comprises one or more plasticizer resins and/or one or more mineral oils having a softening temperature determined according to Test IV of less than 30° C. A plasticizer resin or plasticizer resin mixture is preferred, and very preferably a plasticizer resin or plasticizer resin mixture having a melt viscosity (Test V) at 25° C. and 1 Hz of at least 20 Pa*s, preferably of at least 50 Pa*s. The plasticizer resin is very preferably a hydrocarbon- or polyterpene-based plasticizer resin.

The plasticizer component is preferably present in the pressure-sensitive adhesive in an amount of at least 3 and/or at most 25% by weight, more preferably at least 8% by weight and at most 18% by weight, based on the total weight of the pressure-sensitive adhesive. It has surprisingly emerged that through the use of the plasticizer component, in particular a plasticizer resin, the redetachability of the self-adhesive tape can be further improved. On the other hand, the presence of mineral oil or mixtures of mineral oils, which are also commonly used as plasticizers, has been found to be negative for the redetachability. Therefore, an embodiment is preferred in which the fraction of mineral oil and/or mixtures of mineral oils in the pressure-sensitive adhesive is not more than 3% by weight, more preferably not more than 1.5% by weight.

Despite their negative influence, a higher content of mineral oil and/or mineral oil mixtures may be preferred. For those embodiments in which the fraction of mineral oil and/or mineral oil mixtures is more than 3% by weight with respect to the total weight of the pressure-sensitive adhesive, a fraction of the reinforcing component of preferably at least 10% by weight is selected, likewise with respect to the total weight of the pressure-sensitive adhesive.

To adjust further properties, the pressure-sensitive adhesive may contain further additives. Preferably, however, their fraction is not more than 18% by weight of the pressure-sensitive adhesive, preferably not more than 10% by weight.

These additives are mainly protective agents. These include ageing inhibitors of primary and secondary types, light stabilizers and UV protectants, and also flame retardants, and additionally fillers, dyes and pigments. The pressure-sensitive adhesive layer can be coloured as desired or white, grey or black. Further additives of this kind, or others, that can typically be utilized are:
primary antioxidants such as sterically hindered phenols, for example, preferably with a fraction of 0.2 to 1% by weight, based on the total weight of the pressure-sensitive adhesive,
secondary antioxidants, such as phosphites or thioethers, for example, preferably with a fraction of 0.2 to 1% by weight, based on the total weight of the pressure-sensitive adhesive,
process stabilizers such as C radical scavengers, for example, preferably with a fraction of 0.2 to 1% by weight, based on the total weight of the pressure-sensitive adhesive,
light stabilizers such as UV absorbers or sterically hindered amines, for example, preferably with a fraction of 0.2 to 1% by weight, based on the total weight of the pressure-sensitive adhesive,
processing aids, preferably with a fraction of 0.2 to 1% by weight, based on the total weight of the pressure-sensitive adhesive
optionally further polymers of preferably elastomeric nature; elastomers utilizable accordingly include, among others, those based on pure hydrocarbons, for example unsaturated polydienes such as natural or synthetically produced polyisoprene or polybutadiene, chemically substantially saturated elastomers such as saturated ethylene-propylene copolymers, olefin copolymers, polyisobutylene, butyl rubber, ethylene-propylene rubber, and chemically functionalized hydrocarbons such as, for example, halogenated, acrylate-containing, allyl or vinyl ether-containing polyolefins, preferably with a fraction of 0.2 to 10% by weight, based on the total weight of the pressure-sensitive adhesive.

The at least one pressure-sensitive adhesive layer typically has a layer thickness of approximately at least 10 μm and at maximum 150 μm, more often at least 20 μm and at maximum 100 μm. Layer thicknesses in the range of at least 25 μm and at maximum 60 μm are particularly preferred.

Depending on the embodiment, the pressure-sensitive adhesive may be arranged on one side or on both sides with respect to the carrier, to give a single-sided or a double-sided adhesive tape.

For the purposes of this invention, the general expression “adhesive tape” or “self-adhesive tape” embraces all flat structures such as films or film portions extended in two dimensions, tapes with extended length and limited width, tape portions and the like, and lastly also die-cuts or labels.

The adhesive tape may be produced in the form of a roll, i.e. rolled up on itself in the form of an Archimedean spiral, or covered on its adhesive side with release materials such as siliconized paper or siliconized film.

Suitable release materials are preferably a lint-free material such as a plastic film or a thoroughly sized, long-fibre paper.

The adhesive tapes in particular have running lengths of 25 to 100 m in the form of the usual adhesive tape rolls and from 1000 to 30 000 m in the form of reels.

A reverse-side varnish may be applied to the back of the adhesive tape in order to favourably influence the unwind properties of the adhesive tape wound into an Archimedean spiral. To this end, the reverse-side varnish may be provided with silicone or fluorosilicone compounds or with polyvinylstearyl carbamate, polyethyleneiminestearyl carbamide or organofluorine compounds as abhesive (anti-adhesive) substances. Suitable release agents include surfactant release systems based on long-chain alkyl groups such as stearyl sulfosuccinates or stearyl sulfosuccinamates, but also polymers that may be selected from the group consisting of polyvinylstearyl carbamates, polyethyleneiminestearyl carbamides, chromium complexes of C14 to C28 fatty acids and stearyl copolymers, as described in DE 28 45 541 A, for example. Release agents based on acrylic polymers with perfluorinated alkyl groups, silicones or fluorosilicone compounds, for example based on poly(dimethylsiloxanes), are also suitable. Particularly preferably, the release layer comprises a polymer based on silicone. Particularly preferred examples of such silicone-based releasing polymers include polyurethane-modified and/or polyurea-modified silicones, preferably organopolysiloxane/polyurea/polyurethane block copolymers, particularly preferably such as described in example 19 of EP 1 336 683 B1, very particularly preferably anionically stabilized polyurethane-modified and urea-modified silicones having a silicone weight fraction of 70% and an acid number of 30 mg KOH/g. The use of polyurethane and/or urea-modified silicones has the effect that the products according to the invention have an optimized separation behaviour with optimized ageing resistance and universal writability. In one preferred embodiment of the invention, the release layer comprises 10 to 20% by weight, particularly preferably 13 to 18% by weight, of the releasing constituent.

In addition to the release layer, an antistatic coating may be present on the top of the film, for example in the form of amine or amide waxes such as Atmer (Croda) or Arquad T50, for example. This coating is advantageous because the static adhesion of the adhesive tape to fingers and objects is prevented.

In order to adjust the anchoring of the at least one pressure-sensitive adhesive layer to the at least one carrier layer to the desired degree, the carrier layer is preferably chemically and/or physically pretreated. Chemical pretreatment is carried out by applying a functional layer, in particular by means of a primer layer according to the prior art. Physical pretreatment can be carried out inline or offline by corona treatment (especially under air or nitrogen atmosphere) and/or flame and/or plasma treatment and/or other surface activation methods.

Adhesive tapes according to the invention are preferably used in widths of 9 to 50 mm, in particular 19 to 25 mm and have a preferred thickness of 40 to 200 μm, preferably 50 to 180 μm, further preferably 60 to 130 μm. The chosen widths for the rolls are usually 10, 15, 19, 25, 30 and 50 mm.

The self-adhesive tape according to the invention preferably has a peel adhesion (steel) in the range from 2.5 to 8.5 N/cm, particularly preferably 3.5 to 7.0 N/cm. The peel adhesion can be determined according to the method described in the “Test Methods” section (Test VI). A bond strength in the specified range allows secure fixation of movable objects during transport and at the same time allows easy and residue-free redetachment of the self-adhesive tape.

The self-adhesive tape of the invention further has a thermal shear strength (SAFT) of preferably greater than or equal to 95° C., particularly preferably of greater than or equal to 115° C. The method for determining the thermal shear strength is also described in the “Test Methods” section (Test VII).

It is essential to the invention that the self-adhesive tape has good redetachability, which according to Test Method VIII is at least “+”. For this purpose, the self-adhesive tape does not necessarily have to show a peel adhesion and/or a thermal shear strength in the above-stated preferable performance range.

In addition to good redetachability, the self-adhesive tape of the invention is further distinguished by its sustainable producibility. It has been found here that the use of solvents is not necessary. Therefore, an embodiment is preferred in which the pressure-sensitive adhesive is produced by solvent-free mixing. This is preferably done continuously in a compounding extruder, with twin-screw extruders being particularly preferred.

A further subject of the present invention is a method for producing the self-adhesive tape of the invention. In the context of the production method according to the invention, the pressure-sensitive adhesive is applied solventlessly to the carrier by means of extrusion or contact nozzle coating. The pressure-sensitive adhesive here can be applied to the carrier both on one side and on both sides.

Although solvent-free processing is preferred, it is nevertheless likewise possible to produce and coat the pressure-sensitive adhesive in an organic solvent or in a combination of organic solvents. Self-adhesive tapes are then obtained after drying the coating.

In addition to the method for producing it, the present invention also relates to the use of the self-adhesive tape of the invention. Therefore, a further subject of the present invention is the use of a self-adhesive tape according to the invention as an adhesive fixing tape, for transport securing, for bundling, packaging, palletizing and/or for edge reinforcement.

In addition, the adhesive tape can be used to excellently fix movable parts such as doors, flaps, etc. on printers or refrigerators during transport from the manufacturer to the seller or on to the buyer.

The adhesive tape of the invention can also be used advantageously in the following applications by virtue of the properties described:
a) For the temporary fixing of larger components such as car windshields after insertion into the frame until the PU liquid adhesive cures, to prevent slippage during the curing process.
b) For end tabbing (end-ply bonding) of metal coils with the requirement of residue-free redetachability.
c) For temporary closing of containers or general bonding to surfaces with the requirement for residue-free redetachability.

The present invention is illustrated by means of the following examples, which are by no means to be understood as a restriction of the inventive concept.

### EXAMPLES

The specimens were produced either from solution or solventlessly by extrusion. The selected production method is noted accordingly in each of the individual examples.

Solvent-based, the intended raw materials were weighed out into a glass specimen vessel and provided with a solvent mixture consisting of acetone, special boiling point spirit and toluene (weight fractions 16:54:30 based on the total amount of solvent) and left on a rolling bench for 48 h, so that a 40% by weight solution was obtained. The solutions were coated with a doctor blade onto an 85 μm thick MOPP film pretreated with 60 W min/m² N₂ corona, so that a coatweight of 30 g/m² was obtained after drying at 120° C. for 15 min in a drying oven. The dried pressure-sensitive adhesive layer was covered with a layer of siliconized release paper until further testing.

Specimens were also produced by extrusion. Compounding was carried out in a twin-screw extruder at 180° C., which fed a hotmelt nozzle inline. Coating was carried out in a contact process at 180° C., where the MOPP film to be coated was fed via a counter-roller (chill roll). The chill roll temperature was 15° C. The MOPP film was coated within 24 h after corona pretreatment, which was carried out under nitrogen at 100 W min/m².

### Chemicals Used

| | |
|---|---|
| Component | Description |

Elastomer component

| | |
|---|---|
| Elastomer 1 | SIS linear triblock copolymer; PS fraction 16% |
| | by weight Diblock fraction: 18% by weight |
| | Peak MW: 180 000 g/mol |
| Elastomer 2 | SEBS linear triblock copolymer; PS fraction 13% |
| | by weight Diblock fraction: 29% by weight |
| | Peak MW: 120 000 g/mol |

Tackifier resin component

| | |
|---|---|
| Resin 1 | C₉ HC resin; Softening point: 96° C. |
| | DACP: 45° C. fully hydrogenated |
| Resin 2 | C₅ HC resin; Softening point: 90° C. |
| | DACP: 47° C. |
| Resin 3 | C₉ HC resin; Softening point: 88° C. |
| | DACP: 39° C. fully hydrogenated |

Plasticizer

| | |
|---|---|
| Plasticizer 1 | C₅ HC liquid resin Peak MW: 500 g/mol |
| | MW: 650 g/mol |
| Plasticizer 2 | Naphthenic mineral oil Peak MW: 950 g/mol |
| | MW: 920 g/mol |

Reinforcing component

| | |
|---|---|
| Reinforcer 1 | Aromatic HC resin; Softening point: 153° C. |
| | MMAP: 16° C. MW: 6600 g/mol |
| Reinforcer 2 | Polymerized rosin Softening point: 145° C. |
| | MMAP: −5° C. MW: 546 g/mol |

Additive

| | |
|---|---|
| Additive 1 | Antioxidant based on sterically hindered phenol |
| Additive 2 | Secondary ageing inhibitor based on phosphite |

The following inventive self-adhesive tapes (I) were produced and their properties were analysed and compared with those of comparison adhesive tapes (C) (percentages each in % by weight).

| | I1 | | I2 | | I3 | |
|---|---|---|---|---|---|---|
| Production method | Solvent | | Solvent | | Extrusion | |
| Elastomer 1 | 59.0% | | 59.0% | | 51.0% | |
| Resin 1 | | | 15.0% | | 10.0% | |
| Resin 2 | 15.0% | | | | | |
| Plasticizer 1 | 15.0% | | 15.0% | | 18.0% | |
| Plasticizer 2 | | | | | | |
| Reinforcer 1 | 10.0% | | 10.0% | | 20.0% | |
| Additive 1 | 0.5% | | 0.5% | | 0.5% | |
| Additive 2 | 0.5% | | 0.5% | | 0.5% | |
| Total elastomer component + | 69.0% | | 69.0% | | 71.0% | |
| reinforcing component | | | | | | |
| Peel adhesion | 5.0 | N/cm | 3.1 | N/cm | 3.1 | N/cm |
| SAFT | 123° | C. | 125° | C. | 106° | C. |

| | | | |
|---|---|---|---|
| Redetachability | ++ | ++ | ++ |

| | C1 | | C2 | | C3 | | C4 | |
|---|---|---|---|---|---|---|---|---|
| Production | Solvent | | Solvent | | Solvent | | Extrusion | |
| method | | | | | | | | |
| Elastomer 1 | 45.4% | | 43.5% | | 41.6% | | 52.0% | |
| Resin 1 | | | | | | | 47.0% | |
| Resin 2 | 50.0% | | 47.8% | | 45.8% | | | |
| Plasticizer 1 | | | | | | | | |
| Plasticizer 2 | 4.5% | | 4.3% | | 4.2% | | | |
| Reinforcer 1 | | | 4.3% | | 8.3% | | | |
| Additive 1 | 0.1% | | 0.1% | | 0.1% | | 0.5% | |
| Additive 2 | | | | | | | 0.5% | |
| Total elastomer | 45.4% | | 47.8% | | 49.9% | | 52.0% | |
| component + | | | | | | | | |
| reinforcing | | | | | | | | |
| component | | | | | | | | |
| Peel adhesion | 5.9 | N/cm | 5.9 | N/cm | 5.8 | N/cm | 7.2 | N/cm |
| SAFT | 110° | C. | 113° | C. | 122° | C. | 103° | C. |

| | | | | |
|---|---|---|---|---|
| Redetachability | − | − | −− | −− |

| | I4 | | I5 | | I6 | | I7 | |
|---|---|---|---|---|---|---|---|---|
| Production | Extrusion | | Extrusion | | Extrusion | | Solvent | |
| method | | | | | | | | |
| Elastomer 1 | 56.0% | | 41.0% | | 45.0% | | | |
| Elastomer 2 | | | | | | | 59.0% | |
| Resin 1 | 10.0% | | 29.0% | | 18.0% | | | |
| Resin 2 | | | | | | | 15.0% | |
| Plasticizer 1 | 18.0% | | 16.0% | | 18.0% | | 15.0% | |
| Plasticizer 2 | | | | | | | | |
| Reinforcer 1 | 15.0% | | 13.0% | | 18.0% | | 10.0% | |
| Additive 1 | 0.5% | | 0.5% | | 0.5% | | 0.5% | |
| Additive 2 | 0.5% | | 0.5% | | 0.5% | | 0.5% | |
| Total elastomer | 71.0% | | 54.0% | | 63.0% | | 69.0% | |
| component + | | | | | | | | |
| reinforcing | | | | | | | | |
| component | | | | | | | | |
| Peel adhesion | 3.5 | N/cm | 6.9 | N/cm | 4.5 | N/cm | 1.8 | N/cm |
| SAFT | 113° | C. | 106° | C. | 107° | C. | 129° | C. |

| | | | | |
|---|---|---|---|---|
| Redetachability | ++ | ++ | ++ | ++ |

| | C5 | | C6 | | C7 | | C8 | |
|---|---|---|---|---|---|---|---|---|
| Production | Extrusion | | Extrusion | | Extrusion | | Solvent | |
| method | | | | | | | | |
| Elastomer 1 | 40.0% | | 34.0% | | 66.0% | | 59.0% | |
| Resin 1 | 43.0% | | 37.0% | | 26.0% | | | |
| Resin 2 | | | | | | | 15.0% | |
| Plasticizer 1 | 16.0% | | 14.0% | | 7.0% | | 15.0% | |
| Plasticizer 2 | | | | | | | | |
| Reinforcer 1 | | | 14.0% | | | | | |
| Reinforcer 2 | | | | | | | 10.0% | |
| Additive 1 | 0.5% | | 0.5% | | 0.5% | | 0.5% | |
| Additive 2 | 0.5% | | 0.5% | | 0.5% | | 0.5% | |
| Total elastomer | 40.0% | | 48.0% | | 66.0% | | 69.0% | |
| component + | | | | | | | | |
| reinforcing | | | | | | | | |
| component | | | | | | | | |
| Peel adhesion | 6.2 | N/cm | 8.2 | N/cm | 1.2 | N/cm | 5.8 | N/cm |
| SAFT | 86° | C. | 94° | C. | 106° | C. | 110° | C. |

| | | | | |
|---|---|---|---|---|
| Redetachability | − | −− | −− | − |

| | I8 | | I9 | | I10 | | I11 | |
|---|---|---|---|---|---|---|---|---|
| Production | Extrusion | | Extrusion | | Extrusion | | Extrusion | |
| method | | | | | | | | |
| Elastomer 1 | 45.0% | | 39.0% | | 51.0% | | 57.0% | |
| Resin 1 | 34.0% | | | | 15.0% | | 35.0% | |
| Resin 2 | | | | | | | | |
| Resin 3 | | | 25.0% | | | | | |
| Plasticizer 1 | 11.0% | | 18.0% | | 18.0% | | | |
| Plasticizer 2 | | | | | | | | |
| Reinforcer 1 | 9.0% | | 17.0% | | 15.0% | | 7.0% | |
| Additive 1 | 0.5% | | 0.5% | | 0.5% | | 0.5% | |
| Additive 2 | 0.5% | | 0.5% | | 0.5% | | 0.5% | |
| Total elastomer | 54.0% | | 56.0% | | 66.0% | | 64.0% | |
| component + | | | | | | | | |
| reinforcing | | | | | | | | |
| component | | | | | | | | |
| Peel adhesion | 6.7 | N/cm | 7.1 | N/cm | 7.2 | N/cm | 5.0 | N/cm |
| SAFT | 105° | C. | 105° | C. | 104° | C. | 113° | C. |

| | | | | |
|---|---|---|---|---|
| Redetachability | ++ | + | ++ | ++ |

In contrast to the comparison adhesive tapes C1 to C8, the inventive self-adhesive tapes 11 to 111 have a satisfactory (+) to very good (++) redetachability. As can also be seen from the data, the limitation of the mineral oil fraction and also a fraction of elastomer component and reinforcing components in the pressure-sensitive adhesive of at least 52% by weight has an advantageous effect on the redetachment properties.

### Test Methods:

### Test I—Molar Mass (GPC)

### (a) Peak Molar Mass of Individual Block Copolymer Modes

Polymers are polymodal systems in terms of molecular mass distribution. Mixtures of different polymers can be understood as multimodal systems, with each polymer contributing its own molar mass distribution. Mixtures of block copolymers with structures having different molar mass distributions can also be understood as multimodal systems. Each block copolymer then contributes its own molar mass distribution. For simplicity, these are called block copolymer modes here.

GPC (gel permeation chromatography) is a metrological method for determining the molar mass of individual polymer modes in mixtures of different polymers. For the block copolymers produced by living anionic polymerization which can be used in the sense of this invention, the molar mass distributions are typically sufficiently narrow, so that polymer modes which can be assigned to triblock copolymers, diblock copolymers or multiblock copolymers are sufficiently resolved from each other in the elugram. It is then possible to read off the peak molar mass for the individual polymer modes from the elugrams.

Peak molar masses (Peak MM) of elastomers are determined by GPC. The eluent used is THF. The measurement is made at 23° C. The pre-column used is PSS-SDV, 5μ, 10³ Å, ID 8.0 mm×50 mm. For separation, the columns used are PSS-SDV, 5μ, 10³ Å and 10⁴ Å and 10⁶ Å each with ID 8.0 mm×300 mm. The sample concentration is 4 g/l and the flow rate is 1.0 ml per minute. The calibration is carried out using the commercially available ReadyCal kit Poly(styrene) high from PSS Polymer Standard Service GmbH, Mainz. (μ=μm; 1 Å=10⁻¹⁰ m).

### (b) Weight-Average Molar Mass

The weight-average molecular weight Mw of tackifier resins, plasticizers and reinforcers is determined by means of GPC. The eluent used is THF. The measurement is made at 23° C. The pre-column used is PSS-SDV, 5μ, 10³ Å, ID 8.0 mm×50 mm. For separation, the columns used are PSS-SDV, 5μ, 10³ Å and 10⁴ Å and 10⁶ Å each with ID 8.0 mm×300 mm. The sample concentration is 4 g/l and the flow rate is 1.0 ml per minute. The calibration is carried out using the commercially available ReadyCal kit Poly(styrene) high from PSS Polymer Standard Service GmbH, Mainz.

### Test II—DSC

Glass transition points—referred to synonymously as glass transition temperatures-particularly of polymers or polymer blocks are reported as the result of measurements by means of differential scanning calorimetry (DSC) according to DIN 53 765, especially sections 7.1 and 8.1, but with uniform heating and cooling rates of 10 K/min in all heating and cooling steps (cf. DIN 53 765; section 7.1; note 1). The sample weight is 20 mg. The melting temperature or softening temperature of polymers or polymer blocks is also determined in this way.

### Test IIIa—DACP

5.0 g of test substance (the tackifier resin sample to be examined) are weighed into a dry sample glass, and 5.0 g of xylene (isomer mixture, CAS [1330-20-7], ≥98.5%, Sigma-Aldrich #320579 or comparable) are added. The test substance is dissolved at 130° C. and then cooled down to 80° C. Any xylene escape is made up with additional xylene, so that 5.0 g of xylene are present again. Subsequently, 5.0 g of diacetone alcohol (4-hydroxy-4-methyl-2-pentanone, CAS [123-42-2], 99%, Aldrich #H41544 or comparable) are added. The sample glass is shaken until the test substance has dissolved completely. For this purpose, the solution is heated to 100° C. The sample glass containing the resin solution is then placed into a Novomatics Chemotronic Cool cloud point measuring device, where it is heated to 110° C. It is cooled down at a cooling rate of 1.0 K/min. The cloud point is detected optically. For this purpose, that temperature at which the turbidity of the solution is 70% is registered. The result is reported in ° C. The lower the DACP value, the higher the polarity of the test substance.

### Test IIIb—MMAP

5.0 g of test substance (the tackifier resin specimen under investigation) are weighed into a dry sample glass and 10 mL of dry aniline (CAS [62-53-3], ≥99.5%, Sigma-Aldrich #51788 or comparable) and 5 mL of dry methylcyclohexane (CAS [108-87-2], ≥99%, Sigma-Aldrich #300306 or comparable) are added. The sample glass is shaken until the test substance has dissolved completely. For this purpose, the solution is heated to 100° C. The sample glass containing the resin solution is then placed into a Novomatics Chemotronic Cool cloud point measuring device, where it is heated to 110° C. It is cooled down at a cooling rate of 1.0 K/min. The cloud point is detected optically. For this purpose, that temperature at which the turbidity of the solution is 70% is registered. The result is reported in ° C. The lower the MMAP, the higher the aromaticity of the test substance.

### Test IV—(Tackifier Resin) Softening Temperature

For individual substances: The (tackifier) resin softening temperature (softening point) is carried out according to the relevant method, which is known as ring & ball and is standardized according to ASTM E28.

### Test V—Melt Viscosity

To determine the melt viscosity of the plasticizer resins, a shear stress sweep is carried out in rotation in a shear stress-regulated DSR 200 N rheometer from Rheometrics Scientific. A cone/plate measuring system with a diameter of 25 mm (cone angle 0.1002 rad) is employed; the measuring head is air-mounted and is suitable for standard force measurements. The gap is 0.053 mm and the measuring temperature is 25° C. The frequency is varied from 0.002 Hz to 200 Hz and the melt viscosity at 1 Hz is recorded.

### Test VI—Peel Adhesion, Steel

The determination of the peel adhesion is carried out as follows. A polished steel plate (ASTM D3330; cleaned three times with acetone using a cellulose cloth and evaporated for 10 min) with a thickness of 2 mm is used as a defined adhesion base. The bondable sheetlike element under investigation (30 g/m² pressure-sensitive adhesive layer on 85 μm MOPP film) is cut to a width of 20 mm and a length of about 25 cm, unless otherwise specified, provided with a handling section and immediately afterwards pressed onto the adhesion base back and forth five times with a steel roller of 4 kg at a speed of 10 m/min. Immediately thereafter, the bondable sheetlike element is peeled from the adhesion base at an angle of 180° with a tensile tester (from Zwick) at a velocity v=300 mm/min, and the force required for this purpose at room temperature is measured. The measured value (in N/cm) is obtained as the mean value from two individual measurements.

### Test VII—SAFT

This test is used to quickly test the shear strength of adhesive formulations under temperature load. For this purpose, a test specimen for investigation is adhered to a temperature-controllable steel plate and loaded with a weight (50 g), and the shear distance is recorded.

### Test Sample Preparation:

The test specimen for investigation (30 g/m² on 85 μm MOPP carrier) is cut to a size of 10 mm*50 mm.

The cut-to-size adhesive tape sample is bonded by the other adhesive side to a polished test plate cleaned with acetone (material 1.4301, DIN EN 10088-2, surface 2R, surface roughness Rₐ=30 to 60 nm, dimensions 50 mm*13 mm*1.5 mm), in such a way that the bond area of the sample is height*width=13 mm*10 mm, and the test plate overhangs by 2 mm at the top edge. Then a 2 kg steel roller is rolled over the bond six times at a speed of 10 m/min for fixing. The sample is reinforced flush at the top with a stable adhesive strip which serves as a mount for the distance sensor. Then the sample is suspended by means of the plate so that the longer protruding end of the test specimen points vertically downwards.

### Measurement:

The sample to be measured is loaded with a weight of 50 g at the lower end. The test plate with the bonded sample is heated, starting at 25° C. and at a rate of 9 K/min, to the final temperature of 200° C.

The slip distance of the sample is observed by means of the distance sensor as a function of temperature and time. The maximum slip distance is set to 1000 μm (1 mm); if exceeded, the test is aborted and the failure temperature recorded. Test conditions: Room temperature 23+/−3° C., relative humidity 50+/−5%. The result is reported as the mean value from two individual measurements, and is expressed in ° C.

### Test VIII—Redetachability

A test strip (width 20 mm) is cut to a length of 250 mm and is laminated onto a steel plate (according to ASTM D3330; cleaned three times with acetone with a cellulose cloth and evaporated for 10 minutes) with a thickness of 2 mm using a rubber roller and rolled on back and forth once with a 2 kg steel roller. The assembly is stored at 60° C. and 95% relative humidity for 7 d. It is subsequently equilibrated for 24 h at 23° C. and 50% relative humidity and removed at 10 m/min at an angle of about 170°. Subsequently, the substrate is visually inspected for any adhesive tape residues.

A double determination is carried out and the following rating scale is applied:

| | | |
|---|---|---|
| ++ | ≤1% adhesive residues by area, no carrier splitting | very good pass |
| + | ≤5% adhesive residues by area, no carrier splitting | good pass |
| − | >5% adhesive residues by area, no carrier splitting | fail |
| −− | carrier splitting | fail |

1. Self-adhesive tape comprising a carrier composed of a monoaxially oriented polypropylene film and a pressure-sensitive adhesive which comprises:
a) 38 to 65% by weight of an elastomer component;
b) 8 to 45% by weight of a tackifier resin component; and
c) 2 to 22% by weight of a reinforcing component,
based in each case on the total weight of the pressure-sensitive adhesive, characterized in that the sum of the fractions of elastomer component and reinforcing components in the pressure-sensitive adhesive is at least 52% by weight, based on the total weight of the pressure-sensitive adhesive, and wherein the reinforcing component is at least one resin having a weight-average molecular weight Mw of at least 800 g/mol.

2. Self-adhesive tape according to claim 1, within the thickness of the carrier film after orientation is 20 to 150 μm, preferably 25 to 100 μm.

3. Self-adhesive tape according to claim 1, within the elastomer component is a polydiene block copolymer, more particularly a polyvinylaromatic-polydiene block copolymer.

4. Self-adhesive tape according to claim 1, within the tackifier resin component is selected from the group consisting of non-polar hydrocarbon resins, preferably hydrogenated and non-hydrogenated polymers of dicyclopentadiene; non-hydrogenated, partially, selectively or fully hydrogenated hydrocarbon resins based on C5 or C5/C9 monomer streams, or partially, selectively or fully hydrogenated hydrocarbon resins based on C9 monomer streams, and polyterpene resins based on α-pinene and/or β-pinene and/or δ-limonene.

5. Self-adhesive tape according to claim 1, within the fraction of the tackifier resin component in the pressure-sensitive adhesive is at maximum 40% by weight, particularly preferably at maximum 35% by weight, based in each case on the total weight of the pressure-sensitive adhesive.

6. Self-adhesive tape according to claim 1, within the reinforcing component is at least one resin based on at least one, in particular aromatic, hydrocarbon compound, preferably obtained from C8 and/or C9 streams and preferably selected from the group consisting of styrene, alpha-methylstyrene, para-methylstyrene, indene, methylindene and copolymers thereof, wherein the at least one resin of the reinforcing component preferably has a weight-average molecular weight Mw of 1000 g/mol to 15 000 g/mol, preferably 2000 g/mol to 10 000 g/mol, determined by means of GPC.

7. Self-adhesive tape according to claim 1, within the reinforcing component is contained in an amount of 8 to 18% by weight in the pressure-sensitive adhesive, based in each case on the total weight of the pressure-sensitive adhesive.

8. Self-adhesive tape according to claim 1, within the at least one resin of the reinforcing component has a softening point of at least 130° C., preferably at least 140° C., determined according to ASTM E28.

9. Self-adhesive tape according to claim 1, within the sum of the fractions of elastomer component and reinforcing component in the pressure-sensitive adhesive is at least 55% by weight, preferably at least 60% by weight, based on the total weight of the pressure-sensitive adhesive.

10. Self-adhesive tape according to claim 1, within the pressure-sensitive adhesive further comprises a plasticizer component, preferably in an amount of 3 to 25% by weight, preferably 8 to 18% by weight, based on the total weight of the pressure-sensitive adhesive.

11. Self-adhesive tape according to claim 1, within the fraction of mineral oil and/or mineral oil mixtures in the pressure-sensitive adhesive is not more than 3% by weight, preferably not more than 1.5% by weight, based on the total weight of the pressure-sensitive adhesive.

12. Self-adhesive tape according to claim 1, within the pressure-sensitive adhesive contains further additives, preferably in an amount of not more than 18% by weight, particularly preferably not more than 10% by weight, based on the total weight of the pressure-sensitive adhesive.

13. Self-adhesive tape according to claim 1, within the pressure-sensitive adhesive is produced by solvent-free mixing.

14. Method for producing a self-adhesive tape according to claim 1, within the pressure-sensitive adhesive is applied solventlessly to the carrier by means of extrusion or contact nozzle coating.

15. Use of a self-adhesive tape according to claim 1 as an adhesive fixing tape, for transport securing, for bundling, packaging, palletizing and/or for edge reinforcement.
